(19) United States
(12) Patent Application Publication
(10) Pub. No.: US 2011/0016475 A1
(43) Pub. Date: Jan. 20, 2011

(54) COMMUNICATION MODEL FOR A SCANNER

(75) Inventor: THAO MERNA, Huntington Beach, CA (US)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/505,429

(22) Filed: Jul. 17, 2009

(51) Int. Cl. G06F 13/10

(52) U.S. Cl. 719/321

(57) ABSTRACT

An extension module is generated to act on behalf of a TWAIN application by communicating with a WIA driver via WIA Service. A data structure is transmitted from the extension module to the WIA driver via a custom properties mechanism of WIA Service. The data structure contains a location of a binary data file containing instruction data for the scanner. The binary data file is located with the WIA driver according to the location. The instruction data is transmitted to the scanner, which processes the instruction data and transmits results back to the WIA driver. The WIA driver writes the results into a new binary data file. The data structure is updated and transmitted to the extension module via the custom properties mechanism, and the new binary data file is located. The obtained information is processed by the extension module on behalf of the TWAIN application.

### FIELD

The present disclosure relates to a communication model for a scanner, and more particularly relates to the WIA and TWAIN protocols for scanner drivers, which provide communication between scanner applications and scanner hardware.

### BACKGROUND

In the field of scanners and scanner drivers, the TWAIN protocol has become a de facto standard, and it is therefore common for scanning applications to support only the TWAIN protocol. The TWAIN protocol is a standard software protocol and application program interface (API) that regulates communication between applications and scanner hardware. However, a scanner vendor can not place a Microsoft™ logo on its hardware unless the scanner vendor also provides, with the hardware, a driver that supports a Microsoft™ protocol that is far less common than TWAIN, i.e., the Microsoft™ Windows Image Acquisition (WIA) protocol.

As a result, scanner vendors ordinarily provide two separate drivers: a TWAIN driver for the majority of customers' applications, and a WIA driver so that the hardware can display the Microsoft™ logo. In this way, scanner vendors are able to feature the Microsoft™ logo on the hardware, while still providing support for TWAIN applications.

### SUMMARY

One problem with using two separate, full-blown drivers is that the scanning system may become increasingly unstable as the two separate and unsynchronized drivers independently access the same hardware and software resources. Moreover, development efforts ordinarily must account for two drivers, even though both drivers are essentially performing the same job. While Microsoft™ provides a TWAIN-wrapper to disguise WIA drivers as TWAIN drivers for TWAIN applications, the TWAIN-wrapper is too primitive to be effective or efficient.

The foregoing situation is addressed by passing a data structure to a WIA driver on behalf of a TWAIN application via the WIA custom properties mechanism of WIA Service, wherein the data structure indicates a location of a binary data file containing instruction data for the scanner and result data from the scanner.

Thus, in an example embodiment described herein, communication is provided between a TWAIN application and a WIA driver for a scanner. An extension module which acts on behalf of the TWAIN application is generated, to communicate with the WIA driver via WIA Service. A data structure is transmitted from the extension module to the WIA driver via a custom properties mechanism of WIA Service, and the data structure contains a location of a binary data file containing instruction data for the scanner. The binary data file is located with the WIA driver according to the location contained in the data structure and the instruction data is obtained. The instruction data is transmitted from the WIA driver to the scanner, and the scanner processes the instruction data and transmits results back to the WIA driver. The WIA driver writes the results into a new binary data file according to the instruction data and updates the data structure with the location of the new binary data file. The data structure containing the location of the new binary data file is transmitted from the WIA driver to the extension module via the custom properties mechanism of WIA Service. The new binary data file is located with the extension module according to the location, and the information is obtained. The obtained information is processed by the extension module on behalf of the TWAIN application.

By virtue of this arrangement, in which a data structure is passed to a WIA driver on behalf of a TWAIN application via the WIA custom properties mechanism of WIA Service, it is ordinarily possible to provide the TWAIN application with full access to scanner hardware with a single combination driver. Accordingly, instabilities caused by multiple drivers accessing the same resources are reduced, and development efforts need only account for a single driver.

This brief summary has been provided so that the nature of this disclosure may be understood quickly. A more complete understanding can be obtained by reference to the following detailed description and to the attached drawings.

### BRIEF DESCRIPTION OF THE DRAWINGS

FIG. 1 illustrates an example embodiment of an environment in which aspects of the present disclosure may be practiced.

FIG. 2 is a detailed block diagram depicting the internal architecture of the host computer shown in FIG. 1.

FIG. 3 is a block diagram illustrating the internal architecture of the scanner shown in FIG. 1.

FIG. 4 is a schematic diagram illustrating examples of modules for communicating with a scanner.

FIG. 5 is a flowchart illustrating an example process of communicating with a scanner.

FIG. 6 illustrates a communication module and a scanner, and a simplified view of communication between an extension module, a WIA driver, and a scanner.

### DETAILED DESCRIPTION

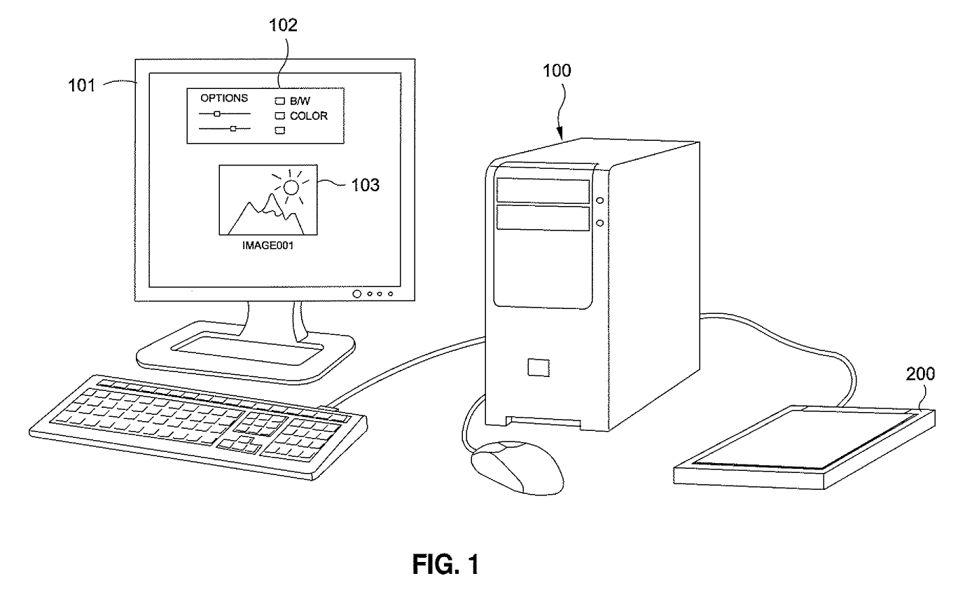

FIG. 1 illustrates an example environment in which aspects of the present disclosure may be practiced. Computer 100 generally comprises a programmable general purpose personal computer having an operating system such as Microsoft® Windows® or Apple® Mac OS® or LINUX, and which is programmed as described below so as to perform particular functions and in effect to become a special purpose computer when performing these functions. As shown in FIG. 1, computer 100 displays a user interface 102 for scanner options on the top of a display screen 101, and an image 103 on the bottom of the screen. Scanner 200 is connected to computer 100, and is used to optically scan a printed image, printed text, handwriting, or an object, and convert it to a digital image.

Host computer 100 also includes computer-readable memory media such as fixed disk 45, which is constructed to store computer-readable information such as computer-executable process steps or a computer-executable program for causing a computer to perform a method of communication between a TWAIN application and a WIA driver for a scanner, as described more fully below.

While FIG. 1 depicts a computer, computing equipment for practicing aspects of the present disclosure can be implemented in a variety of embodiments. For example, in an image processing environment, the computing equipment might be included in a digital camera or digital video recorder. In a medical image processing environment, the computing equipment might be a CT scanner or X-ray machine. Other embodiments are possible according to the application and environment.

In FIG. 1, scanner 200 is depicted as a desktop (or flatbed) scanner where the document is placed on a glass window for scanning. However, scanner 200 can be implemented as other image capture devices. For example, scanner 200 could be embodied as a hand-held scanner, where the device is moved by hand. Scanner 200 could also be embodied as a mechanically driven scanner for large-format documents where a flatbed design would be impractical. Scanner 200 could also include a document feeder.

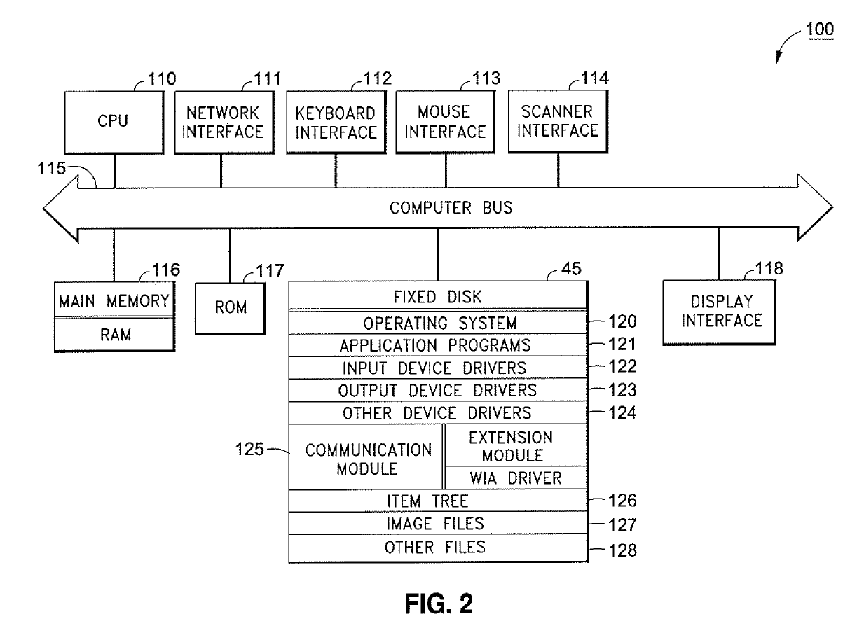

FIG. 2 is a detailed block diagram depicting the internal architecture of the computer 100 shown in FIG. 1. As shown in FIG. 2, host computer 100 includes central processing unit (CPU) 110 which interfaces with computer bus 115. Also interfacing with computer bus 115 are fixed disk 45 (e.g., a hard disk or other nonvolatile storage medium), network interface 111, keyboard interface 112, mouse interface 113, scanner interface 114, random access memory (RAM) 116 for use as a main run-time transient memory, read only memory (ROM) 117, and display interface 118 for display screen 101. Scanner interface 114 interfaces with scanner 200 via a connection such as a general purpose bus, a Small Computer System Interface (SCSI), a USB connection, a FireWire connection, or another connection, and may be configured to transmit data over a wired or wireless network.

RAM 116 interfaces with computer bus 115 so as to provide information stored in RAM 116 to CPU 110 during execution of the instructions in software programs such as an operating system, application programs, communication modules, and device drivers. More specifically, CPU 110 first loads computer-executable process steps from fixed disk 45, or another storage device into a region of RAM 116. CPU 110 can then execute the stored process steps from RAM 116 in order to execute the loaded computer-executable process steps. Data such as capability or calibration information, color images or other information can be stored in RAM 116, so that the data can be accessed by CPU 110 during the execution of the computer-executable software programs, to the extent that such software programs have a need to access and/or modify the data.

As also shown in FIG. 2, fixed disk 45 contains computer-executable process steps for operating system 120, and application programs 121, such as word processing programs or graphic image management programs. Fixed disk 45 also contains computer-executable process steps for device drivers for software interface to devices, such as input device drivers 122, output device drivers 123, and other device drivers 124. Item tree 126 stores calibration and/or capability information of scanner 200, which can be used to generate a user interface on behalf of scanner 200. Image files 127, including scanned image files, and other files 128 are available for output to output devices and for manipulation by application programs.

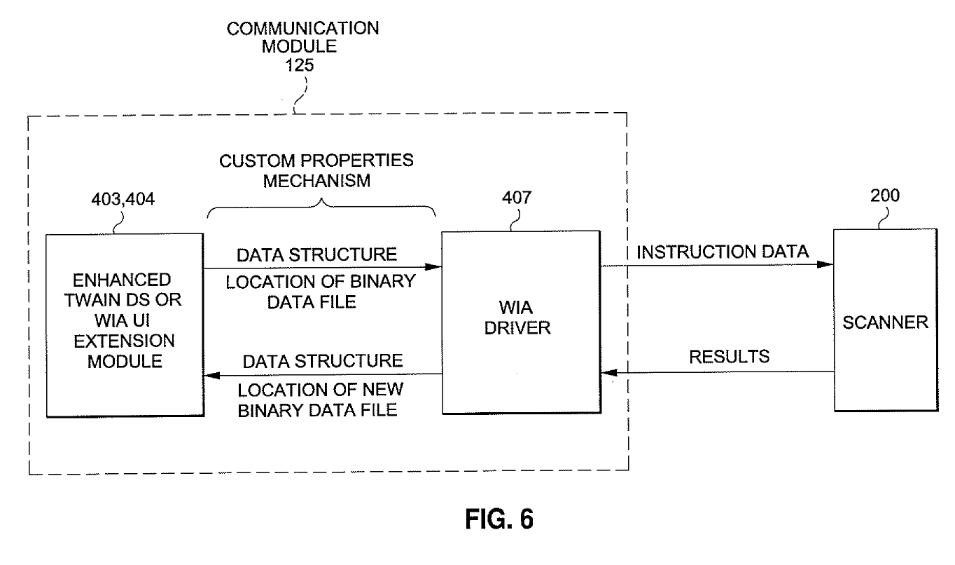

Communication module 125 comprises computer-executable process steps for providing communication between a TWAIN application and a WIA driver for a scanner. Communication module 125 generally comprises an extension module (such as a WIA User Interface Extension Module or a TWAIN Data Source) and a WIA driver, as shown in FIG. 6.

More specifically, communication module 125 comprises an extension module configured to act on behalf of the TWAIN application to communicate with the WIA driver via WIA Service, and configured to transmit a data structure to the WIA driver via a custom properties mechanism of WIA Service. The data structure contains a location of a binary data file containing instruction data for the scanner. The extension module subsequently locates a new binary data file according to a received location and processes obtained information on behalf of the TWAIN application. Communication module 125 also generally comprises the WIA driver, configured to locate the binary data file according to the location contained in the data structure, to obtain the instruction data, and to transmit the instruction data to the scanner which processes the instruction data and transmits results back to the WIA driver. The WIA driver writes the results into a new binary data file and updates the data structure with the location of the new binary data file. The WIA driver transmits the data structure containing the location of the new binary data file to the extension module via the custom properties mechanism of WIA Service. These processes will be described in more detail below.

The computer-executable process steps for communication module 125 may be configured as a part of operating system 120, as part of an output device driver such as a printer driver, or as a stand-alone application program. They may also be configured as a plug-in or dynamic link library (DLL) to the operating system, device driver or application program. For example, communication module 125 according to example embodiments may be embedded in the firmware of an input device such as a scanner or an output device such as a printer, or may be provided in a stand-alone communication application for use on a general purpose computer. In one example embodiment described herein, communication module 125 is incorporated directly into the operating system for host computer 100. It can be appreciated that the present disclosure is not limited to these embodiments and that the disclosed communication module may be used in other environments.

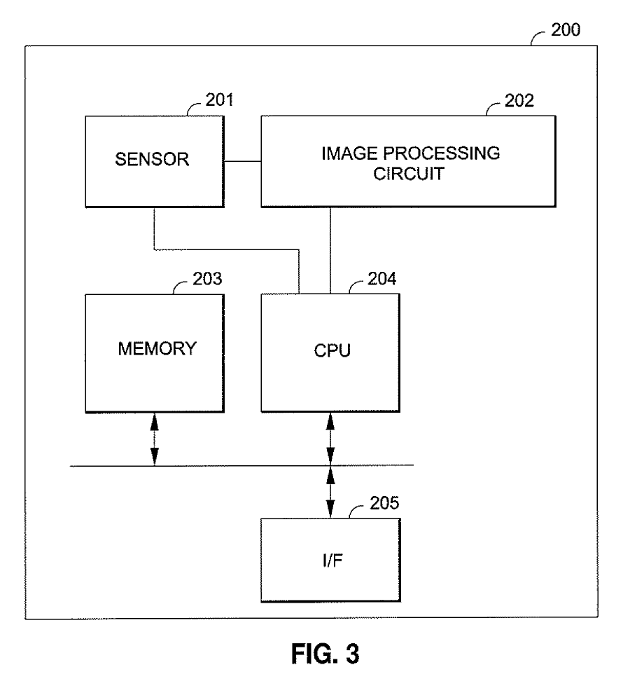

FIG. 3 is a block diagram of the architecture of scanner 200. For purposes of simplicity, only basic components of scanner 200 are shown and a detailed explanation of the components of scanner 200 is not provided herein.

In FIG. 3, scanner 200 includes a reading sensor 201 which captures an image, and an image processing circuit 202 which processes the image signal from the sensor 201. Memory 203 stores a program to be executed by CPU 204 to control the scanner. Interface 205 receives commands from connected devices such as computer 100, and transmits the command to the CPU 204. Interface 205 also outputs resultant data to connected devices such as computer 100. Interface 205 could include, for example, a parallel port, a general purpose bus, a Small Computer System Interface (SCSI), a USB connection, a FireWire connection, or other connections, and may be configured to transmit data over a wired or wireless network.

As discussed above, most computers include separate, full-blown TWAIN and WIA drivers to communicate with a scanner, leading to system instability and wasted resources.

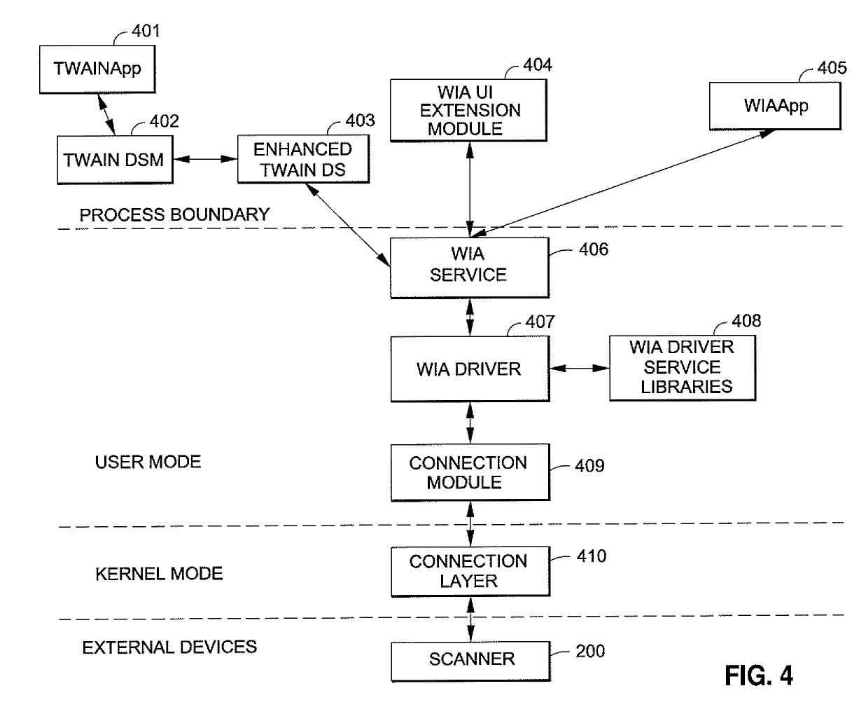

Therefore, a process for providing communication between a TWAIN application and a WIA driver for a scanner will now be discussed with respect to FIGS. 4 to 6.

FIG. 4 depicts examples of different modules which may be used in the communication process. Each of the modules are computer-executable software code or process steps executable by a processor such as CPU 110, and are stored on a computer-readable storage medium such as fixed disk 45. More or less modules may be used than those shown in FIG. 4, and other architectures are possible. Some modules are Microsoft (e.g., WIA) modules, some modules are third-party modules, and some modules are independent software vendor modules.

TWAINApp 401 corresponds to the TWAIN application executing on computer 100. Thus, for example, TWAINApp 401 might be an authoring application that permits insertion of images acquired via a TWAIN interface, such as Adobe™ Acrobat.

TWAIN DSM 402 is a TWAIN Data Source Manager. The primary role of TWAIN DSM 402 is to establish and manage connections between TWAINApp 401 and TWAIN data sources which convert TWAIN commands for different devices. Ordinarily, when the application needs to communicate with a TWAIN data source, it calls TWAIN DSM 402 with a correctly addressed message. TWAIN DSM 402 ordinarily allows an application and/or a user to select a desired source, loads and unloads the selected source, and makes sure that all calls from a particular application are correctly routed to the appropriate source.

According to this embodiment, however, TWAIN DSM 402 is coupled to Enhanced TWAIN Data Source 403 (hereafter “Enhanced TWAIN DS 403”). Enhanced TWAIN DS 403 is one of the extension modules which communicates with WIA Service 406 on behalf of TWAINApp 401. As discussed more fully below, Enhanced TWAIN DS 403 transmits instruction data for scanner 200 to WIA driver 407 by passing a data structure to WIA driver 407, and subsequently receives the data structure containing the results of the request. Enhanced TWAIN DS 403 then processes the obtained information on behalf of TWAINApp 401. In that regard, Enhanced TWAIN DS 403 can perform numerous commands on behalf of TWAINApp 401 and TWAIN DSM 402, such as returning the name of the current file.

WIA User Interface extension module 404 (hereafter “WIA UI extension module 404”) is another extension module which can communicate with WIA driver 407 via the custom properties mechanism of WIA Service 406. WIA UI extension module 404 transmits instruction data for scanner 200 to WIA driver 407 by passing a data structure to WIA driver 407, and subsequently receives the data structure containing the location of a new binary data file storing the results of the request. WIA UI extension module 404 locates the new binary data file according to the location, and displays the results on behalf of TWAINApp 401. For example, WIA UI extension module 404 can use capability and/or calibration data obtained from scanner 200 to fill out item tree 126 on fixed disk 45, and then can use the information from item tree 126 to construct a robust and extended user interface for scanner 200.

WIAApp 405 corresponds to, for example, purely WIA applications or other non-TWAIN applications which already communicate via the WIA protocol.

WIA Service 406 communicates with Enhanced TWAIN DS 403 and WIA extension module 404 across the process boundary. WIA Service 406 is a locally running service which is provided with the WIA protocol to allow applications to communicate with WIA driver 407. Of particular note, WIA Service 406 includes a custom properties mechanism which allows user-created parameters to be passed to WIA driver 407. As discussed below, the custom properties mechanism is used to pass a data structure to WIA driver 407, and a data structure is received from the WIA driver 407 using the custom properties mechanism.

WIA driver 407 communicates with Enhanced TWAIN DS 403 or WIA UI extension module 404 in order to pass instructions on behalf of TWAINApp 401 to scanner 200 and to return results from scanner 200. Specifically, WIA driver 407 receives a data structure from Enhanced TWAIN DS 403 or WIA UI extension module 404, locates a binary data file containing instruction data for scanner 200 according to a location contained in the data structure, transmits the instruction data to scanner 200, writes results from scanner 200 to a new binary data file, updates the data structure with the location of the new binary data file, and transmits the data structure back to Enhanced TWAIN DS 403 or WIA UI extension module 404. In one embodiment, WIA driver 407 is a WIA minidriver loaded by WIA service 406.

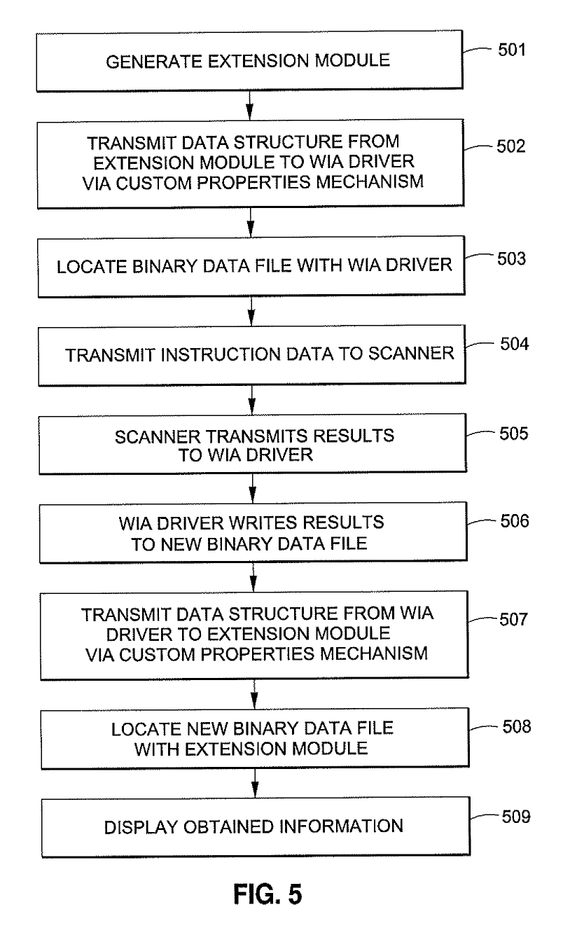

WIA Driver Service Libraries 408 is also shown in FIG. 5. WIA Driver Service Libraries 408 is a system-supplied component that provides helper functions for WIA driver 407.

Connection module 409 provides communication between WIA driver 407 and scanner 200 via connection layer 410. Connection layer 410 can comprise, for example, a TCP/IP layer, a USB physical layer, or a Bluetooth Physical Layer.

FIG. 5 is a flowchart illustrating an example process of communicating with a scanner.

Briefly, in FIG. 5, communication is provided between a TWAIN application and a WIA driver for a scanner. An extension module which acts on behalf of the TWAIN application is generated, to communicate with the WIA driver via WIA Service. A data structure is transmitted from the extension module to the WIA driver via a custom properties mechanism of WIA Service, and the data structure contains a location of a binary data file containing instruction data for the scanner. The binary data file is located with the WIA driver according to the location contained in the data structure and the instruction data is obtained. The instruction data is transmitted from the WIA driver to the scanner, and the scanner processes the instruction data and transmits results back to the WIA driver. The WIA driver writes the results into a new binary data file according to the instruction data and updates the data structure with the location of the new binary data file. The data structure containing the location of the new binary data file is transmitted from the WIA driver to the extension module via the custom properties mechanism of WIA Service. The new binary data file is located with the extension module according to the location, and the information is obtained. The obtained information is processed by the extension module on behalf of the TWAIN application.

In more detail, in step 501, computer 100 generates an extension module to act on behalf of TWAINApp 401. The extension module transmits instructions on behalf of TWAINApp 401, and processes results from scanner 200 on behalf of TWAINApp 401.

In this regard, the particular type of extension module acting on behalf of TWAINApp 401 depends on the request from TWAINApp 401. Specifically, if the request or command from TWAINApp 401 is to display a user interface, WIA UI extension module 404 may communicate on behalf of TWAINApp 401 to request capabilities from scanner 200. The capabilities can then be written to item tree 126 on fixed disk 45, and may subsequently be used to display an extended user interface on behalf of TWAINApp 401. On the other hand, if TWAINApp 401 requests image data from scanner 200, Enhanced TWAIN DS 403 may communicate on behalf of TWAINApp 401 and transmit the resultant image data to TWAINApp 401.

In some cases, Enhanced TWAIN DS 403 and WIA UI extension module 404 cooperate to perform overall functionality, but only one of Enhanced TWAIN DS 403 or WIA UI extension module 404 may perform actual communication with a WIA driver (as described below). For example, Enhanced TWAIN DS 403 may initially receive a request for a user interface, but may simply relay this request to WIA UI extension module 404 for performing the remainder of the processing.

In step 502, a data structure is transmitted from the extension module to WIA driver 407 via the custom properties mechanism of WIA Service 406. In one embodiment, the data structure may be received via a dialog box object controlled by WIA UI extension module 404.

The custom properties mechanism is a specific method of transmitting data in the WIA protocol. Callers can manipulate custom properties just as they would normal WIA properties. Thus, the WIA custom properties mechanism allows passage of user-generated parameters to WIA driver 407. Moreover, WIA Service 406 understands how to process the custom properties, and thus little translation or other packaging is required.

The data structure transmitted from the extension module to WIA driver 407 includes at least three elements. In particular, the data structure includes at least the name of a command, an element indicating the type of data to be expected, and an element indicating the information. For example, the command could be “SendCalibrationData”, the data type could be integers, and the information could be a character string containing the name and the location of the binary data file, e.g., “c:\drivers\temp.bin”.

In that regard, the command string is of a particular type which instructs WIA driver 407 to access the file given in the location and to take certain actions with the data found in the binary data file (such as transmitting to scanner 200), and also indicates to WIA driver 407 what to do with the results received from scanner 200 (such as writing resultant data to a new binary data file or files).

The binary file is a computer file which may contain any type of data, encoded in binary form. For example, a binary data file may store instruction data for scanner 200 or result data from scanner 200. The binary data file should be located in an installation area of operating system 120, or another portion of memory where it can be accessed easily by WIA driver 407 or the extension module without excessive security restrictions. The instruction data for a respective command may be written to a binary data file or files prior to transmission of the data structure to WIA driver 407.

In step 503, WIA driver 407 locates the binary data file according to the location contained in the data structure, and obtains the instruction data stored therein. The contents of the instruction data in the binary data file depend on the application and the requested data. Thus, in one example, the instruction data can correspond to a request for capabilities of scanner 200 or calibration data. In another example, the instruction data can correspond to a request for image data from scanner 200.

In step 504, WIA driver 407 transmits the instruction data to scanner 200.

In step 505, scanner 200 processes the received instruction data and transmits results back to WIA driver 407. For example, if the instruction data corresponds to a request for calibration data, scanner 200 transmits calibration data to WIA driver 407. On the other hand, if the instruction data corresponds to a request for image data, scanner 200 transmits raw image data to WIA driver 407.

In step 506, WIA driver 407 writes the results received from scanner 200 into a new binary data file. In this regard, multiple new binary data files may be used to store results from scanner 200. For example, if multiple images are input by scanner 200, it may be necessary to store the resultant image data in a plurality of new binary data files. In such case, WIA driver 407 can return, via the information element of the data structure, a list of the locations of all of the plurality of data files. WIA driver 407 updates the data structure with the location of the new binary data file(s), so that the extension module can locate the results.

In step 507, WIA driver 407 transmits the data structure back to the extension module via the custom properties mechanism. The data structure now contains the location of the new binary data file, so that the extension module can locate the results from scanner 200.

In step 508, the extension module locates the new binary data file, using the location contained in the data structure. Accordingly, the extension module can obtain the calibration data, the image data, or other results from scanner 200.

In step 509, the extension module processes the information obtained from the new binary data file on behalf of TWAINApp 401.

The processing by the extension module depends on the instruction data transmitted on behalf of TWAINApp 401. For example, if the instruction data corresponds to a request for capabilities of scanner 200, WIA UI extension module 404 can use this information to display an extended user interface on behalf of TWAINApp 401. In this regard, since WIA driver 407 obtains the capabilities according to the native WIA protocol of scanner 200, WIA UI extension module 404 may be able to provide a more robust user interface. Moreover, since WIA UI extension module 404 can display such information on behalf of TWAINApp 401, the native user interface of TWAINApp 401 may be entirely unnecessary.

In one embodiment, calibration and/or capability data can be obtained from scanner 200 prior to the user interacting with scanner 200. For example, Enhanced TWAIN DS 403 could query WIA driver 407 for calibration or capability data of a paper feeder or scanner flatbed upon start-up or installation of scanner 200. The acquired data could then be written to item tree 126 on fixed disk 45, so that an extended user interface can be generated and readily available by the time TWAINApp 401 needs to access those data. Calibration data may also be obtained when a user requests to import an image.

Conversely, it may be possible for a user to select and set parameters using the communication process described above. For example, WIA UI extension module 404 could pass a data structure with instruction data corresponding to user selections of scanner capabilities from the user interface, and the dialog box controlled by WIA UI extension module 404 could be used to receive instructions or selections from the user for transmission to scanner 200.

In another example, if the instruction data corresponds to a request for image data from scanner 200, Enhanced TWAIN DS 403 can act as the extension module. Specifically, the image data can be obtained by Enhanced TWAIN DS 403 and transferred to TWAINApp 401. Moreover, the image data can ordinarily be obtained more efficiently than in many image acquisition methods. In particular, Enhanced TWAIN DS 403 can obtain image data of an entire image from WIA driver 407, and then transmit a notification to TWAINApp 401 once the image data of the entire image is stored in the new binary data file. Thus, image data of an entire image may be acquired by Enhanced TWAIN DS 403 before the image data is transferred to TWAINApp 401. Accordingly, rather than TWAINApp 401 having to obtain image data piece by piece, the user simply requests image data and the full image is returned from Enhanced TWAIN DS 403. Of course, the image data can also be transferred in bands if desired.

FIG. 6 is a simplified view of communication between Enhanced TWAIN DS 403 or WIA UI extension module 404 (shown together), a WIA driver, and a scanner. Enhanced TWAIN DS 403/ WIA UI extension module 404 and WIA driver 407 together comprise communication module 125. As previously described, communication module 125 is stored on fixed disk 45 of computer 100, and comprises computer-executable process steps for providing communication between a TWAIN application and a WIA driver for a scanner.

As shown in FIG. 6, Enhanced TWAIN DS 403/WIA UI extension module 404 passes the data structure containing the location of the binary data file through the custom properties mechanism to WIA driver 407, and receives the data structure, now containing the location of a new binary data file, from the WIA driver 407. WIA driver 407 passes instruction data to scanner 200, and receives results from scanner 200.

By virtue of the above-described arrangements, it is ordinarily possible to provide a TWAIN application with full access to scanner hardware with a single combination driver, thereby reducing instabilities caused by accessing resources with multiple drivers. In addition, development efforts need only account for a single driver.

This disclosure has provided a detailed description with respect to particular representative embodiments. It is understood that the scope of the appended claims is not limited to the above-described embodiments and that various changes and modifications may be made without departing from the scope of the claims.

What is claimed is:

1. A method of communicating between a TWAIN application and a WIA driver for a scanner, comprising:
generating an extension module which acts on behalf of the TWAIN application to communicate with the WIA driver via WIA Service;
transmitting a data structure from the extension module to the WIA driver via a custom properties mechanism of WIA Service, wherein the data structure contains a location of a binary data file containing instruction data for the scanner;
locating the binary data file with the WIA driver according to the location contained in the data structure and obtaining the instruction data;
transmitting the instruction data from the WIA driver to the scanner, wherein the scanner processes the instruction data and transmits results back to the WIA driver, which writes the results into a new binary data file according to the instruction data and updates the data structure with the location of the new binary data file;
transmitting the data structure containing the location of the new binary data file from the WIA driver to the extension module via the custom properties mechanism of WIA Service;
locating the new binary data file with the extension module according to the location and obtaining the information; and
processing the obtained information by the extension module on behalf of the TWAIN application.

2. The method according to claim 1, wherein the extension module is a WIA User Interface extension module, and wherein the processing includes displaying the obtained information on behalf of the TWAIN application.

3. The method according to claim 2, wherein the instruction data corresponds to a request for capabilities of the scanner, wherein the scanner sends capability information back to the WIA driver, and wherein the WIA User Interface extension module displays a user interface on behalf of the TWAIN application.

4. The method according to claim 1, wherein the extension module is an Enhanced TWAIN data source, and wherein the processing of the obtained information includes transmitting the obtained information to the TWAIN application.

5. The method according to claim 4, wherein the instruction data corresponds to a request for image data from the scanner, wherein the scanner transmits image data back to the WIA driver, and wherein the image data is obtained by the Enhanced TWAIN data source and transferred to the TWAIN application.

6. The method according to claim 5, wherein image data of an entire image is obtained by the Enhanced TWAIN data source before the image data is transferred to the TWAIN application.

7. The method according to claim 6, wherein the Enhanced TWAIN data source transmits a notification to the TWAIN application once the image data of the entire image is stored in the new binary data file.

8. The method according to claim 1, wherein the binary data file and new binary data file are located in an installation area of the operating system.

9. The method according to claim 1, wherein the data structure further comprises a command for the WIA driver.

10. The method according to claim 1, wherein the WIA driver is a minidriver loaded by WIA Service.

11. A communication apparatus, comprising:
a computer-readable memory constructed to store computer-executable process steps; and
a processor constructed to execute the computer-executable process steps stored in the memory;
wherein the process steps stored in the memory cause the processor to provide communication between a TWAIN application and a WIA driver for a scanner, and include computer-executable process steps to:
generate an extension module which acts on behalf of the TWAIN application to communicate with the WIA driver via WIA Service;
transmit a data structure from the extension module to the WIA driver via a custom properties mechanism of WIA Service, wherein the data structure contains a location of a binary data file containing instruction data for the scanner;
locate the binary data file with the WIA driver according to the location contained in the data structure and obtaining the instruction data;
transmit the instruction data from the WIA driver to the scanner, wherein the scanner processes the instruction data and transmits results back to the WIA driver, which writes the results into a new binary data file according to the instruction data and updates the data structure with the location of the new binary data file;
transmit the data structure containing the location of the new binary data file from the WIA driver to the extension module via the custom properties mechanism of WIA Service;
locate the new binary data file with the extension module according to the location and obtaining the information; and
process the obtained information by the extension module on behalf of the TWAIN application.

12. The apparatus according to claim 11, wherein the extension module is a WIA User Interface extension module, and wherein the processing includes displaying the obtained information on behalf of the TWAIN application.

13. The apparatus according to claim 12, wherein the instruction data corresponds to a request for capabilities of the scanner, wherein the scanner sends capability information back to the WIA driver, and wherein the WIA User Interface extension module displays a user interface on behalf of the TWAIN application.

14. The apparatus according to claim 11, wherein the extension module is an Enhanced TWAIN data source, and wherein the processing of the obtained information includes transmitting the obtained information to the TWAIN application.

15. The apparatus according to claim 14, wherein the instruction data corresponds to a request for image data from the scanner, wherein the scanner transmits image data back to the WIA driver, and wherein the image data is obtained by the Enhanced TWAIN data source and transferred to the TWAIN application.

16. The apparatus according to claim 15, wherein image data of an entire image is obtained by the Enhanced TWAIN data source before the image data is transferred to the TWAIN application.

17. The apparatus according to claim 16, wherein the Enhanced TWAIN data source transmits a notification to the TWAIN application once the image data of the entire image is stored in the new binary data file.

18. The apparatus according to claim 11, wherein the binary data file and new binary data file are located in an installation area of the operating system.

19. The apparatus according to claim 11, wherein the data structure further comprises a command for the WIA driver.

20. The apparatus according to claim 11, wherein the WIA driver is a minidriver loaded by WIA Service.

21. A communication module for providing communication between a TWAIN application and a WIA driver for a scanner, comprising:
an extension module configured to act on behalf of the TWAIN application to communicate with the WIA driver via WIA Service, and configured to transmit a data structure to the WIA driver via a custom properties mechanism of WIA Service, wherein the data structure contains a location of a binary data file containing instruction data for the scanner, wherein the extension module subsequently locates a new binary data file according to a received location and processes obtained information on behalf of the TWAIN application; and
the WIA driver, configured to locate the binary data file according to the location contained in the data structure, to obtain the instruction data, and to transmit the instruction data to the scanner which processes the instruction data and transmits results back to the WIA driver, wherein the WIA driver writes the results into a new binary data file and updates the data structure with the location of the new binary data file, and wherein the WIA driver transmits the data structure containing the location of the new binary data file to the extension module via the custom properties mechanism of WIA Service.

22. A computer-readable storage medium storing computer-executable process steps for causing a computer to perform a method of communication between a TWAIN application and a WIA driver for a scanner, the method comprising:
generating an extension module which acts on behalf of the TWAIN application to communicate with the WIA driver via WIA Service;
transmitting a data structure from the extension module to the WIA driver via a custom properties mechanism of WIA Service, wherein the data structure contains a location of a binary data file containing instruction data for the scanner;
locating the binary data file with the WIA driver according to the location contained in the data structure and obtaining the instruction data;
transmitting the instruction data from the WIA driver to the scanner, wherein the scanner processes the instruction data and transmits results back to the WIA driver, which writes the results into a new binary data file according to the instruction data and updates the data structure with the location of the new binary data file;
transmitting the data structure containing the location of the new binary data file from the WIA driver to the extension module via the custom properties mechanism of WIA Service;
locating the new binary data file with the extension module according to the location and obtaining the information; and
processing the obtained information by the extension module on behalf of the TWAIN application.
